(19) United States
(12) Patent Application Publication
(10) Pub. No.: US 2012/0276387 A1
(43) Pub. Date: Nov. 1, 2012

(54) High-Temperature Assembly, Method for Producing High-Temperature Assembly, and Heat-Resistant Sealing Material

(75) Inventors: Hirokatsu Hattanda, Gifu (JP); Tomohiro Yotabun, Gifu (JP)

(73) Assignee: TYK CORPORATION, Tokyo (JP)

(21) Appl. No.: 13/509,586

(22) PCT Filed: Nov. 15, 2010
(86) PCT No.: PCT/JP10/06700

§ 371 Date: May 11, 2012

(30) Foreign Application Priority Data
Nov. 18, 2009 (JP) 2009-262935
Jun. 10, 2010 (JP) 2010-132541
Sep. 10, 2010 (JP) 2010-203079

(51) Int. Cl. C04B 35/10; B32B 18/00; B32B 37/12; B32B 37/06; C04B 35/00; C04B 35/18

(52) U.S. Cl. 428/402; 501/94; 501/128; 501/119; 156/322; 156/325; 428/448; 428/697

(57) ABSTRACT

It is provided a high-temperature assembly that is favorable for increasing the sealing property at the boundary area between a first member and a second member that are used in a high-temperature environment. Further it is provided a method for producing the high-temperature assembly, and a heat-resistant sealing material. The heat-resistant sealing material, which is disposed at the boundary area between a first member and a second member, comprises ceramic particles made of a plurality of materials which form a ceramics the volume of which increases when the ceramics is synthesized.

### TECHNICAL FIELD

The present invention relates to a high-temperature assembly such as a tundish upper nozzle, production method of high-temperature assembly and the heat-resistant sealing material used for these.

### BACKGROUND OF ART

The gas blowing nozzle performing a gas bubbling by flowing the gas into a metal bath such as molten bath has been used. The gas blowing nozzle comprises a refractory material with gas channel for flowing the gas and an iron cover which surrounds the refractory material. (patent document 1). However, the improvement of sealing property at the boundary area between the refractory material and the iron cover has been requested. In addition the molten bath nozzle for passing a molten bath such as molten steel has been provided. The molten bath nozzle comprises a refractory material with molten bath channel for passing the gas and a iron cover surrounding the refractory material. In this case the improvement on sealing property at the boundary area between the refractory material and the iron cover has been also requested.

### LIST OF RELATED ART DOCUMENTS

### Patent Documents

Patent Document 1: Japanese Patent Application Laid-Open No. JP2007-262471

### DISCLOSURE OF THE INVENTION

### Problems to be Solved by the Invention

The present invention is to provide the high-temperature assembly favorable for improving sealing property at the boundary area between the first and second members which are used in high temperature environment of heating, production method of the high-temperature assembly and heat-resistant sealing material.

### Means for Solving the Problems

The high-temperature assembly according to the present invention, being used in high temperature, comprises at least first and second members and a heat-resistant sealing material provided at a boundary area between said first and second members, characterized in that said heat-resistant sealing material comprises first and second ceramic particles as effective ingredients forming a ceramics, the volume of which increases when the first and the second ceramic particles are synthesized. The comprising as effective elements means to comprise as a ceramic particles forming a ceramics the volume of which increases when the ceramics is synthesized (baked). The high-temperature assembly is used in high temperature area, for example, 800˜2000° C. For example, the heat-resistant sealing material is heated in the high temperature area, for example, 800˜2000° C. for a long time.

The method for producing a high-temperature assembly according to the present invention is characterized in that the method comprises the steps of:
a first process for preparing a heat-resistant sealing material comprising first and second ceramic particles as effective elements and forming a ceramics the volume of which increases when the first and the second ceramic particles are synthesized and first and second members;.
a second process for forming an assembly by assembling said first and second members, wherein said heat-resistant sealing material before being synthesized is interposed at a boundary area between the first and second members; and
a third process for baking said heat-resistant sealing material by heating at least at one of a using temperature of said assembly at use, a heating temperature of said assembly before use and a heating temperature of said assembly before loading with interposing said heat-resistant sealing material at the boundary between said first member and said second member and synthesizing said first and second ceramic particles to form a ceramics the volume of which increases thereby to seal the boundary area between the first and second members of said assembly.

The ceramic material of the present invention is a heat-resistant sealing material located at the boundary area between the first and second members and it is characterized with comprising the first and second ceramic particles as effective elements to form a ceramics the volume of which increases when the ceramics are synthesized (baked).

As explained above, the heat-resistant sealing material before synthesizing (before baking) is interposed at a boundary area between the first and second members. Under such state, the heat-resistant sealing material before synthesizing (before baking) is heated and baked at least at one of a using temperature of said assembly at use, a heating temperature of said assembly before use and a heating temperature of said assembly before loading. The ceramics is formed by synthesizing (baking) the first and second ceramic particles constituting the heat-resistant sealing material to seal the boundary area between the first and second members of the assembly. In this case, the heat-resistant sealing material expands and forms a sealing layer. The expansion of the sealing layer remains. The sealing property between the boundary of first member and second member can be enhanced due to the residual expansion of the sealing layer. For example, the heating temperature (temperature at use) of the assembly falls in a high temperature range, for example in the range between 800˜2000° C. Accordingly, the first and second ceramic particles contained in the heat-resistant sealing material form a ceramics (for example, mullite and spinel, etc) the volume of which increases more than the volume before the reaction because the heat-resistant sealing material before synthesizing interposed at the boundary area between the first and second members is also heated at the high temperature.

### EFFECT OF THE INVENTION

As explained above, according to the present invention, the first and second ceramic particles which constitute the heat-resistant sealing material are synthesized (baked, calcined) and form a ceramics thereby to seal the boundary area between the first and second members of said assembly. In this case, the sealing performance at the boundary area between the first and second members can be improved. The heat-resistant sealing material can be coated directly on a member which is required to have a high sealing property before synthesizing because the heat-resistant sealing material is a heat-resistant sealing agent before synthesizing. When the heat-resistant sealing material is baked, the heat-resistant sealing material expands and forms a sealing layer with residual expansion thereof. The heat-resistant sealing material expands (residual expansion) and enhances the sealing effect at the gap. As for the baking (synthesizing) of the heat-resistant sealing part, it may be heated and baked at the temperature of the high temperature assembly at use. Otherwise, it may be heated and baked at the stage before the use of high temperature assembly and at the stage before loading into the factory of high temperature assembly. In addition, heating and baking at the temperature of high temperature assembly at use can simplify and facilitate the total process because the baking process of heating and baking the heat-resistant sealing part can be omitted.

### BRIEF DESCRIPTION OF THE DRAWINGS

FIG. 1 is a cross sectional figure of the tundish upper nozzle for an embodiment 1.

FIG. 2 is a cross sectional figure of the tundish upper nozzle for an embodiment 2.

FIG. 3 is a cross sectional figure of the blowing plug for an embodiment 5.

FIG. 4 is a cross sectional figure of the blowing plug for this embodiment 5 which is cut along the line IV-IV in FIG. 3.

FIG. 5 is a graph of the gas leak test result from the test example.

FIG. 6 is a photo figure expressing the microscope photo of the texture of sealing layer for the test example.

FIG. 7 is a cross sectional figure of the tundish upper nozzle for an embodiment 7.

FIG. 8 is a cross sectional figure of the tundish upper nozzle for an embodiment 8.

FIG. 9 is a cross sectional figure of the main part for this embodiment 8.

FIG. 10 is a cross sectional figure of the tundish upper nozzle for an embodiment 9.

FIG. 11 is a cross sectional figure of the tundish upper nozzle for an embodiment 10.

### EXPLANATION OF THE REFERENCE NUMERALS

1 is an upper porous refractory material, 2 is a lower porous refractory material, 3 is a dense refractory material, 3a is an upper dense refractory material, 3b is a lower dense refractory material, 4 is an upper gas induction channel, 5 is a lower gas induction channel, 6 is an exterior iron cover, 7 is a channel, 8 is a sealing layer and 9 is an iron cover.

### THE BEST MODES FOR CARRYING OUT THE INVENTION

According to the heat-resistant sealing material of the present invention, the ceramics the volume of which increases is preferably a mullite. In this case, it is preferable that the first ceramic particle is formed of silica and the second ceramic particle is formed of alumina. In this case, mullite is synthesized (baked, calcined) according to the chemical reaction shown in the following formula (1)

2SiO₂+3Al₂O₃→3Al₂O₃·2SiO₂ (mullite) (1)

The volume of the synthesized mullite (3Al₂O₃·2SiO₂) increases more than the volume thereof before the reaction. In this case, pores in the sealing agent tend to be closed. When the formula (1) is considered, it is preferable that the heat-resistant sealing material comprises more alumina (Al₂O₃) than silica (SiO₂) in terms of the mass ratio (mole ratio).

For example, the heat-resistant sealing material can be formed by mixing the material containing silica (SiO₂) and more alumina (Al₂O₃) than SiO₂ with the dispersion medium such as water.

In addition, the ceramics, the volume of which increases when the ceramics is synthesized, is preferably a spinel. In this case, it is preferable that the first ceramic particle is formed of magnesia and the second ceramic particle is formed of alumina. In this case, spinel is synthesized (baked, calcined) according to the chemical reaction shown in the following formula (2).

MgO+Al₂O₃→MgO·Al₂O₃ (spinel) (2)

The volume of the synthesized spinel (MgO·Al₂O₃) expands more than the volume thereof before the reaction.

The particle diameter of one of the first and second ceramic particles which constitute the heat-resistant sealing material before synthesizing is set to preferably 30 μm or less. In this case, the particle diameter of one of the first and second ceramic particles is preferably set to either 30 μm or less, 20 μm or less or 10 μm or less, and is set especially preferable to 5 μm or less. The reactivity can be raised when the particle diameter is smaller. When the particle diameter of the other of the first and second ceramic particles is preferably set to either 200 μm or less, 100 μm or less, 50 μm or less, 30 μm or less, and is set especially preferable to 20 μm or less. The thickness of the sealing layer made with the heat-resistant sealing material before and after synthesizing is for example set to 0.2˜20 mm and 0.2˜10 mm although such thickness depends on the. condition of use, the size or the type of the high temperature assembly.

The high temperature assembly of the present invention comprises a first member, a second member, and a heat-resistant sealing material located at a boundary area between the first member and the second member used in high temperature area. The heat-resistant sealing material before synthesizing comprises the first and second ceramic particles as effective elements to form a ceramics the volume of which increases when synthesized. The sealability or the sealing performance at the boundary area between the first and second members is enhanced as the volume of the ceramics increases. With regard to the selection of combination of the first and second members, the combination of a refractory material and a metal, a refractory material and a refractory material, and a metal and a metal are exemplified. As far as the metal is concerned, carbon steel, alloy steel, cast iron, cast steel, titan, titan alloy, aluminum and aluminum alloy can be used. The thermal conductivity to the heat-resistant sealing material is heightened when the metal exists for the combination of the first and second members. As far as the refractory material, it is taken for example at least one of a porous refractory material and a dense refractory material. The metal has at least one of tube shape, box shape, wall shape and panel shape for example.

The heat-resistant sealing material before synthesizing may comprise at least one of kyanite and andalusite mixed in response to the necessity in the heat-resistant sealing material before synthesizing. Kyanite and andalusite are the ores of sillimanite series. Here, assuming that the content of the ceramics in the heat-resistant sealing material before synthesizing is 100%, 0.01˜40% of mass ratio of at least either of a kyanite or an andalusite can be adopted. The sealing performance of the sealing layer can be improved because kyanite and andalusite expand respectively when they are heated. It is considered that the sillimanite series ores become mullite and silica when it is synthesized by heating. The volume of mullite changes (expansion) because the specific gravity thereof is smaller than that of the sillimanite series ores. The bigger the residual expansion is, the bigger the particle diameters of the kyanite and andalusite are, and the effect derived from the residual expansion cannot be obtained when the particle diameter is small.

### Embodiment 1

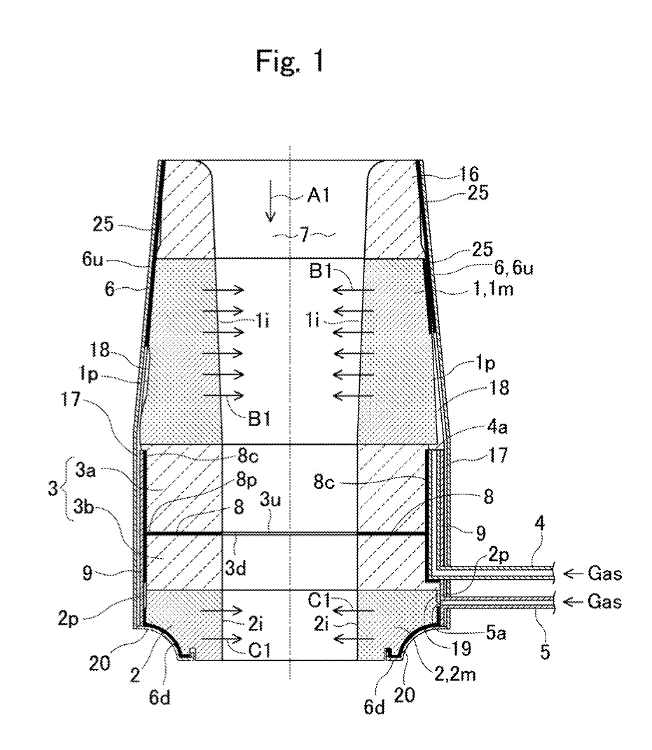

Hereinafter, the first embodiment 1 of the present invention is explained with reference to FIG. 1. The blowing nozzle is a tundish upper nozzle (high temperature assembly). This nozzle is an upper nozzle of a tundish sliding nozzle equipment attached at the bottom of the tundish which reserves the molten metal used for a continuous caster. The tundish upper nozzle comprises a tubular upper porous refractory material 1 having fine pores 1m which exhibits gas penetration property and being located at relatively upper side, a tubular lower porous refractory material 2 having fine pores 2m which exhibits gas penetration property and being located at relatively lower side compared to the upper porous refractory material 1, a tubular dense refractory material 3 interposed between the upper porous refractory material 1 and the lower porous refractory material 2, an upper gas induction pipe 4 as an upper gas induction channel which supplies an intake gas to the upper porous refractory material 1, a lower gas induction pipe 5 as a lower gas induction channel which supplies the intake gas to the lower porous refractory material 2 and a tubular exterior iron cover 6 which functions as an iron cover of metal cover body which holds the upper porous refractory material 1, the dense refractory material 3 and the lower porous refractory material 2 by surrounding the outer periphery thereof. Thus, the channel 7 for passing molten metal bath which extends in the upper and lower direction is formed. In addition, numeral 16 designates a sub dense refractory material stacked on the top of the upper porous refractory material 1. As is shown in FIG. 1, the dense refractory material 3 is divided into an upper dense refractory material 3a and a lower dense refractory material 3b. The “dense” means a magnitude of density is denser than a porous refractory material and gas penetrability is lower than the porous refractory material under the same thickness condition. Sealing layer 8 is formed between the upper dense refractory material 3a and the lower dense refractory material 3b by filling the heat-resistant sealing material therebetween. The iron cover (inner metal body) 9 is shrink-fitted by heating to the outer periphery face of the upper dense refractory material 3a, the lower dense refractory material 3b and the lower porous refractory material 2. The iron cover 9 is located at the inner side of the exterior iron cover 6. This part is double-covered by the iron covers. The sealing layer 17 is interposed between the iron cover 6 (the first member) and the iron cover 9 (the first member).

The upper gas induction pipe 4 is formed such that the edge 4a of the upper gas induction pipe 4 may face upwards along the outer periphery of the dense refractory material 3. The edge 4a of the upper gas induction pipe 4 is connected to the exterior part 1p of the upper porous refractory material 1, through a gas pool 18 having ring shape or tubular shape. The gas leakage is prevented since the sealing layer 8c is formed by filling the heat-resistant sealing material as same with the sealing layer 8 at a boundary area between the inner periphery of the iron cover 9 and the outer periphery of the dense refractory material. The lower gas induction pipe 5 is formed with the edge 5a thereof facing horizontally and is connected with the exterior part 2p of the lower porous refractory material 2 through the ring shaped gas pool 19. The upper porous refractory material 1 and the lower porous refractory material 2 have many connecting fine pores which can pass the gas therethrough and are preferably made of same or same series of material. Alumina series, magnesia series and zirconia series can be exemplified as examples of material. The dense refractory material 3 and the sub dense refractory material 16 are formed of a refractory material baked so as to have high density and having extremely low porosity, low gas penetrative performance, high density and high strength, different from the characteristics of the non-baked castable layer. In other words, the dense refractory material 3 has density due to the gas penetrative performance lower than the performance of the upper porous refractory material 1 and lower porous refractory material 2. The “low gas penetrative performance” means lower gas penetrative performance in the thickness direction under the same thickness condition.

The heat-resistant sealing material before synthesizing which forms the sealing layer 8, 8c and 17 comprises alumina (Al₂O₃) and silica (SiO₂) as main elements (effective elements). With regard to composition of the heat-resistant sealing material, it is desirable to comprise more alumina (Al₂O₃) than silica (SiO₂) in mass ratio (mole ratio). For example, the silica (SiO₂) and alumina (Al₂O₃) the volume of which is more than that of silica (SiO₂) are mixed together to form the heat-resistant sealing material. And the heat-resistant sealing material before synthesizing is applied to the boundary area between the lower surface 3d of the upper dense refractory material 3a (the first member) and the upper surface 3u of the lower dense refractory material 3b (the second member). Thus the sealing agent before synthesizing is coated at the boundary area. When the blowing nozzle is used in this state, the blowing nozzle is maintained in high temperature area. In this case, for example, the molten metal in high temperature, about 1400˜1600° C. flows through the channel 7 in the arrow direction A1. Thus during the use of the high temperature assembly, the following reaction represented by the formula (1) is taken place at the sealing agent by the influence of heat from the high temperature molten metal. Since the iron covers 6, and 9 and the refractory materials 1, 2, 3a, 3b, and 16 have thermally conductive property, these can contribute to heating of the heat-resistant sealing material.

2SiO₂+3Al₂O₃→3Al₂O₃·2SiO₂ (1)

As shown in the formula (1), mullite (3Al₂O₃·2SiO₂) in SiO₂ of mole ratio 2 and Al₂O₃ in mole ratio 3 is synthesized. The volume of the synthesized 3Al₂O₃·2SiO₂ (mullite) expands more than the volume thereof before the reaction. When the sealing layer 8, 8c and 17 made of the mullite are observed with microscope, the pores in sealing layers 8, 8c and 17 are closed. Thus the heating process of synthesizing does not have to be performed separately, because mullite (3Al₂O₃·2SiO₂) is synthesized and the volume of mullite expands more than the volume thereof before the reaction due to the heat generated during the use of the gas blowing nozzle as a high temperature assembly. Here, the smaller the particle diameters of silica particle (SiO₂) and alumina particle (Al₂O₃) are, the easier the synthesizing reaction in formula (1) occurs. Accordingly it is preferable to reduce the diameters of the silica particle (SiO₂) and alumina particle (Al₂O₃) as smaller as possible. It is preferable to prepare the particle diameters of silica particle (SiO₂) and alumina particle (Al₂O₃) to be either 100 μm or less, 30 μm or less, 10 μm or less, or 3 μm or less, and is desirably set to 1 μm or less.

According to one example pattern, the particulate diameter of the silica particle (SiO₂) is set to 3 μm or less, or 1 μm or less, and the particulate diameter of the alumina particle (Al₂O₃) is set to 75 to 1 m or less in consideration of high density filling to the sealing layers 8, 8c and 17. Here, in the composition of the heat-resistant sealing material before synthesizing, the silica (SiO₂) being 5˜50 mass % and the remained part being alumina (Al₂O₃) are desirable in terms of volume expansion. In addition, it is more desirable when the silica (SiO₂) is set to 10˜20 mass % and the remained part contains alumina (Al₂O₃). It is preferable that the ceramics of the sealing agent before the synthesizing has 95% or more, 98% or more or 100% or more actually in summed mass ratio of alumina and silica. Therefore, it is considered to be preferable for the heat-resistant sealing material before the baking (before synthesizing reaction) not to comprise other elements such as magnesia, zirconia.

Accordingly, the composition of the ceramics of heat-resistant sealing material before synthesizing may be proposed for samples as (a)˜(e). However, the composition is not limited thereto within the scope of the invention.
(a) The composition of 70% of the alumina particle (Al₂O₃) having the particulate diameter of 75 m or less, 15% of alumina particle (Al₂O₃) having the particulate diameter of 10 μm or less, and 15% of silica particle (SiO₂) having the particulate diameter of 1 μm or less.
(b) The composition of 70% of the alumina particle (Al₂O₃) having the particulate diameter of 75 μm or less, 15% of alumina particle (Al₂O₃) having the particulate diameter of 10 μm or less, and 15% of silica particle (SiO₂) having the particulate diameter of 3 μm or less.
(c) The composition of 70% of the alumina particle (Al₂O₃) having the particulate diameter of 100 μm or less, 10% of alumina particle (Al₂O₃) having the particulate diameter of 10 μm or less, and 20% of silica particle (SiO₂) having the particulate diameter of 3 μm or less can be used, but not limited thereto.
(d) composition of 60% of the alumina particle (Al₂O₃) having the particulate diameter of 50 μm or less, 20% of alumina particle (Al₂O₃) having the particulate diameter of 10 μm or less, and 20% of silica particle (SiO₂) having the particulate diameter of 1 μm or less can be used.
(e) The composition of 50% of the alumina particle (Al₂O₃) having the particulate diameter of 30 μm or less, 10% of alumina particle (Al₂O₃) having the particulate diameter of 10 μm or less, and 40% of silica particle (SiO₂) having the particulate diameter of 1 μm or less can be used. % means the mass %. The alumina which is not synthesized to mullite remains as alumina. The alumina in the sealing layer can contribute to improvement of the heat resistance performance of the sealing layer.

Next, the gas flow during the use of the gas blowing nozzle in continuous casting process according to this embodiment will be explained. A molten metal such as a molten steel in the tundish which transfers from a ladle flows towards the continuous caster during use, but the molten metal flows downwards (the direction of arrow A1 shown in FIG. 1.) inside the channel 7. In this case, a gas (for example, inactive gas like argon gas) is supplied to the upper gas induction pipe 4 and lower gas induction pipe 5 from the gas source. The gas supplied to the upper gas induction pipe 4 is supplied to porous part in the upper porous refractory material 1 through a gas pool 18 and is blown out from the inner periphery face 1i of the upper porous refractory material 1 toward channel 7 (in the direction of arrow B1). This inhibits alumina from sticking at the top of the nozzle. The gas supplied to the lower gas supply pipe 5 is supplied to the porous part of the lower porous refractory material 2 through a gas pool 19, and is blown out from the inner periphery face 2i of the lower porous refractory material 2 to the channel 7 (in the direction of arrow C1). This inhibits alumina from sticking to sliding plate, collector nozzle and immerse plate in the tundish sliding nozzle equipment.

Since the dense refractory material 3 is made of a baked dense refractory material, which is different from non-baked castable, the dense refractory material 3 has smaller porosity and smaller gas penetration property than the porous refractory materials 1, 2, but a minute amount of gas may penetrate therethrough. In other words, a part of the gas supplied to the upper porous refractory material 1 may penetrate through the upper dense refractory material 3a and may be going to leak to the lower dense refractory material 3b. Similarly, a part of the gas supplied to the lower porous refractory material 2 may penetrate through the lower dense refractory material 3b and may be going to leak to the upper dense refractory material 3a. On the other hand, according to this embodiment, shown in FIG. 1, the synthesized sealing layer 8 is interposed at the boundary area between the lower surface 3d of the upper dense heat-resistant sealing material 3a and the upper surface 3u of the lower dense heat-resistant sealing material 3b. Owing to this structure, the leakage from the upper dense refractory material 3a to the lower dense refractory material 3b is blocked. In addition, the leakage from the lower dense refractory material 3b to the upper dense refractory material 3a is blocked. Consequently, the gas supply to the upper porous refractory material 1 and the lower porous refractory material 2 can be performed independently of each other.

In addition, the heat-resistant sealing material forming the sealing layer 8 has a composition with difficulties in creating a gap between the upper dense refractory material 3a and lower dense refractory material 3b because the volume increases by baking (synthesizing). Accordingly, leakage of the gas from sealing layer 8 can be prevented even under a high temperature use. In addition, iron cover 9 surrounding the exterior face of the upper dense refractory material 3a, lower dense refractory material 3b and lower porous refractory material 2 is installed. It inhibits the gas from flowing along the exterior of the upper dense refractory material 3a, lower dense refractory material 3b and lower porous heat-resistant sealing material 2 because the outer periphery rim 8p of the sealing layer 8 is in contact with the interior wall of iron cover 9. Accordingly, it becomes more advantageous for supplying the gas to upper porous refractory material 1 and lower porous refractory material 2 independently. In addition, sealing layer 8c formed of the same heat-resistant sealing material as the sealing layer 8 is filled between the iron cover 9 and dense refractory material 3 which is in contact with the pipe 4. Thus the gas is not exposed through the exterior of the pipe 4. Accordingly, the gas supply can be performed more independently than the upper porous refractory material 1 and lower porous refractory material 2.

According to this embodiment, the set of an upper part comprising the upper porous refractory material 1 and upper dense heat-resistant sealing material 3a and the set of a lower part comprising the lower porous refractory material 2 and lower dense refractory material 3b can be assembled by gluing with the heat-resistant sealing material constituting the sealing layer 8, as the heat-resistant sealing material fills the gap between the upper dense heat-resistant sealing material 3a and the lower dense refractory material 3b. In addition, according to this embodiment, as explained above, the sealing layer 17 formed of the heat-resistant sealing material is interposed between the iron cover 6 (one of the first and second members.) and iron cover 9 (the other of the first and second members.). The refractory material forming the sealing layer 17 comprises the silica particle (SiO₂) and alumina particle (Al₂O₃) as effective elements.

The sealing layer 20 is formed by coating the heat-resistant sealing material at the boundary area of the lower part 6d of external iron cover 6 (one of the first and second members) and the lower porous refractory material 2 (the other of the first and second members). Moreover, the sealing layer 25 is formed by coating the heat-resistant sealing material at the boundary area between the internal circumference of upper part 6u of the exterior iron cover 6 (the first member) and the exterior of the sub dense refractory material 16 (the second member). And the sealing agent constituting the sealing layers 8, 8c, 17, 20 and 25 are made of heat-resistant sealing material as explained above. The sealing layers 8, 8c, 17, 20, 25 are heated at high temperature by transferring heat from molten metal such as molten steel as the molten metal passes through the channel 7 in the high temperature molten steel when using the gas blowing nozzle. Therefore, the silica particle (SiO₂) and alumina particle (Al₂O₃) constituting the corresponding sealing agent synthesize mullite and expand in the thickness direction relative to the sealing layer. Owing to this structure, the sealing property of the above described sealing layers 8, 8c, 17, 20 and 25 are heightened. In addition, as described in detail above, even though the sealing layers 8, 8c, 17, 20 and 25 are formed with the heat-resistant sealing material according to this embodiment, but without limitation thereto, at least one of the sealing layers 8, 8c, 17, 20 and 25 may be formed of the heat-resistant sealing material according to this embodiment and others may be formed of known sealing agent (mortar and etc).

### Embodiment 2

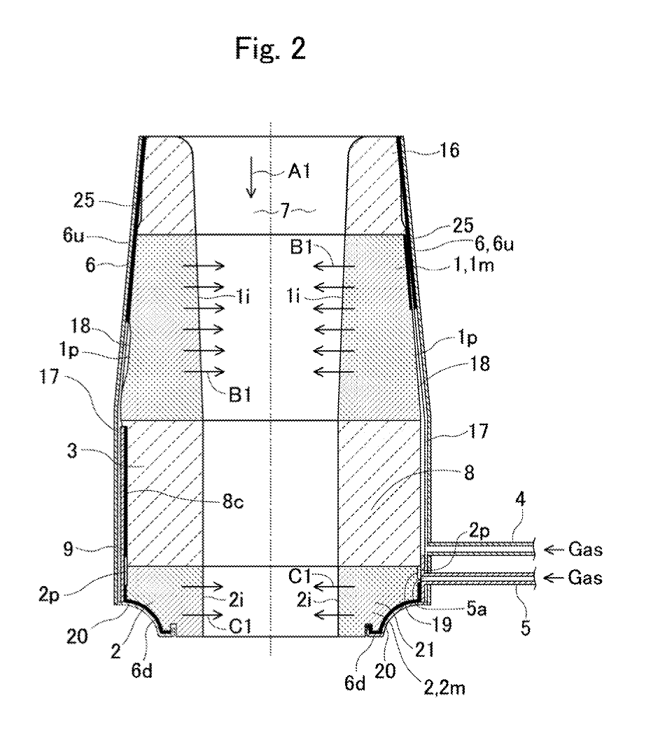

FIG. 2 shows this embodiment 2. This embodiment has the same constitution and same action effect basically. However, the following points are different. The dense refractory material 3 is divided into the upper dense refractory material 3a and lower dense refractory material 3b in this embodiment shown in FIG. 1. And the sealing layer 8 is formed by being filled with the heat-resistant sealing material which synthesize the mullite when it is baked as described in the above between the upper dense refractory material 3a and lower dense refractory material 3b. However, the sealing layer 8 in embodiment 1 is not formed in this embodiment because the dense refractory material 3 has an unified shape of the upper dense refractory material 3a and lower dense refractory material 3b as shown on the FIG. 2. The sealing layer 8c, 17, 20 and 25 are formed of the refractory material according to this embodiment. Without limitation to this, at least one of the sealing layers 8c, 17, 20, and 25 may be formed of the refractory material according to this embodiment and the other may be formed of known sealing agent (mortar and etc).

### Embodiment 3

This embodiment 3 has the same constitution and functional effect with embodiment 1 and 2 basically. Assuming that the ceramics in the heat-resistant sealing material before synthesizing is 100%, in mass ratio, the ceramics comprises 0.1˜30% of silica particle (SiO₂), 50˜70% of alumina particle (Al₂O₃), and 0.1˜20% (0.1˜10%, 0.1˜50%) of one or two particle of andalusite and kyanite. As the andalusite and kyanite (called also as kayanite.), being aluminum silicate (Al₂SiO₅), expand when heated, they expand during the use and the sealing property can be heightened. The particle diameter of the andalusite or kyanite can be selected when necessary, and 1˜1000 μm, 1˜100 μm and 5˜50 μm can be taken as examples, but not limited thereto. The larger the particle diameters of kyanite and andalusite are, the bigger the residual expansion. The effect of residual expansion is hardly obtained when the particle diameter is small. Depending on the situation, the mixing ratio of the andalusite particle and/or kyanite particle can be made in 1˜30% of mass ratio. The uniform texture is hardly obtained when the particles of the andalusite and kyanite are too big. In addition, it is considered that the expansion continues due to the increase of change ratio of the residual expansion curve after baking when the adding quantity of andalusite or kyanite increase. However, when the adding quantity of the andalusite or kyanite increase excessively, the residual expansion enlarges too much, and the texture may be weakened as the expansion continues thereby generating delamination.

### Embodiment 4

FIGS. 1 and 2 shall be applied to the embodiment 4 because of having the same constitution and functional effect with the embodiment 1 and 2 basically. However, the following points are different. The ceramics the volume of which expands when is synthesized in using the heat-resistant sealing material is spinel in this embodiment. Accordingly, the first ceramic particle is formed of magnesia and the second ceramic particle is formed of alumina in the heat-resistant sealing material. The heat-resistant sealing material forming the above described sealing layer 8, 8c, 17, 20 and 25 comprises alumina (Al₂O₃) and magnesia (MgO) as main elements (effective elements). The ceramics composition of the heat-resistant sealing material preferably comprises more alumina (Al₂O₃) than magnesia (MgO) in mass ratio. For example, it is preferable to use the heat-resistant sealing material which is formed by mixing material containing magnesia (MgO) and more alumina (Al₂O₃) than silica (SiO₂) with water. And such heat-resistant sealing material is coated at the boundary area between the lower face 3d of the upper dense refractory material 3a (the first member) and the upper face 3u of the lower dense refractory material 3b (the second member). Thus the sealing agent before synthesizing is coated at this boundary area. The blowing nozzle is maintained in the high temperature area when using the blowing nozzle in this state. For example, the high temperature molten metal in about 1400˜1600° C. flows along the channel 7 to the direction of arrow A1. The following reaction represented by the formula (2) occurs in the sealing agent due to the heat acceptance from the molten metal.

MgO+Al₂O₃→MgO·Al₂O₃ (2)

The spinel is synthesized with MgO of mole ratio 1 and Al₂O₃ of mole ratio 1. The volume of spinel (MgO·Al₂O₃) expands than before the reaction. The heating process (synthesizing process) does not have to be performed independently because spinel is synthesized (baked, calcined) at use the volume of which expands more than before the reaction by the heat in using the gas blowing nozzle which is a high temperature assembly as described in the above. The easier the synthesizing reaction as shown in formula (2) occurs, the smaller the particle diameters of magnesia particle (MgO) and alumina particle (Al₂O₃). Thus it is preferable that the diameters of the magnesia particle (MgO) and alumina particle (Al₂O₃) are small. The particle diameters of magnesia particle (MgO) and alumina particle (Al₂O₃) are preferably 100 μm and less, more preferably 50 μm or less, or 10 μm or less, desirably 1 μm or less.

According to one embodiment, for example, it is preferable that the particle diameter of magnesia particle (MgO) is 1 or less, the particle diameter of alumina particle is 75˜1 μm in consideration of filling the sealing layer 8, 8c, 17, 20 and 25 with high density. Here, the ceramics made with the heat-resistant sealing material before synthesizing preferably comprises substantially 95% or more of alumina and silica, 98% or more thereof, or 100% thereof. It is preferable that the ceramics constituted with the heat-resistant sealing material before synthesizing preferably comprises 1˜50 mass % of the magnesia (MgO) and the residual of alumina (Al₂O₃) in terms of volume expansion. In addition, it is more preferable that it comprises 1˜20 mass % of magnesia (MgO) and the residual of alumina (Al₂O₃). The following patterns of (a)˜(c) can be adopted.
(a) The composition of 70% of the alumina particle (Al₂O₃) having the particle diameter of 75 μm or less, 15% of alumina particle (Al₂O₃) having the particle diameter of 10 μm or less and 15% of magnesia particle (MgO) having the particle diameter of 1 μm or less can be used.
(b) The composition of 70% of the alumina particle (Al₂O₃) having the particle diameter of 75 μm or less, 15% of alumina particle (Al₂O₃) having the particle diameter of 10 μm or less and 15% of magnesia particle (MgO) having the particle diameter of 3 μm or less can be used.
(c) The composition of 70% of the alumina particle (Al₂O₃) having the particle diameter of 100 μm or less, 10% of alumina particle (Al₂O₃) having the particle diameter of 10 μm or less and 20% of magnesia particle (MgO) having the particle diameter of 3 μm or less can be used. But it is not limited to this only.

The sealing layer 8, 8c, 17, 20 and 25 are formed of the heat-resistant sealing material in this embodiment which synthesizes spinel when is baked. Without limitation to this, at least one of the sealing layers 8, 8c, 17, 20, and 25 is formed of the heat-resistant sealing material synthesizing spinel according to this embodiment, but the formation of the residual with publically known sealing agent is accepted.

### Embodiment 5

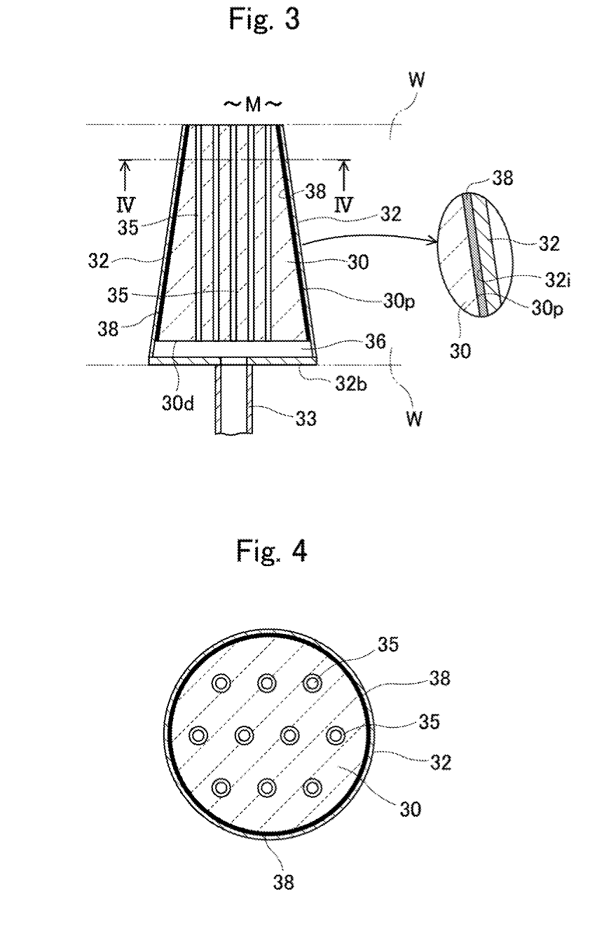

FIGS. 3 and 4 show the embodiment 5. This embodiment has the same constitution and same functional effect basically which have been explained above. However, the following points are different. This embodiment explains the case of application to the blowing plug (high-temperature assembly) which is embedded in the floor of ladle W so as to be attached thereto. The blowing plug comprises a refractory material layer 30, an iron cover 32 surrounding the outer periphery 30p of the refractory material layer 30 and a gas supply pipe 33 connected to the floor 32b of the iron cover 32. The refractory material layer 30 comprises a gas channel 35 for flowing a bubbling gas to molten metal, a gas pool room 36 formed among the lower surface 30d of refractory material layer 30 and iron cover 32 and connecting the gas channel 35. The sealing layer 38 constituted of the heat-resistant sealing material is formed between the outer periphery 30p of the refractory material layer 30 and the inner periphery 32i of the iron cover 32. The ceramics of heat-resistant sealing material forming the sealing layer 38 contains alumina particle (Al₂O₃) and silica particle (SiO₂) as main elements (effective elements) such as the embodiment 1. The ceramics of the heat-resistant sealing material before synthesizing preferably comprises more alumina (Al₂O₃) than silica (SiO₂) in mass ratio (mole ratio). For example, it is preferable to use the heat-resistant sealing material formed by mixing silica (SiO₂) and more alumina (Al₂O₃) than silica (SiO₂) with water. And such heat-resistant sealing material is coated on the outer periphery 30p of the refractory material layer 30 and/or the inner periphery 32i of the iron cover 32. The sealing material before synthesizing shall be coated on the boundary area.

Then, the refractory material layer 30 and the iron cover 32 are assembled. The blowing nozzle is maintained in the high temperature area in case of using the blowing nozzle in this state. In this case, the blowing plug is embedded in the floor W of ladle which stores the molten metal at the high temperature for example 1400˜1650° C. Thus the following reaction of formula (1) occurs and mullite is synthesized in the sealing material due to the heat received from the molten metal M. Owing to this structure, the sealing performance can be heightened at the boundary area of the outer periphery 30p of refractory material layer 30 (one of the first and second members) and inner periphery 32i of the iron cover 32 (another one of the first and second materials). Kyanite can be mixed into the heat-resistant sealing material before synthesizing depending on necessity.

### Embodiment 6

This embodiment has basically the same constitution, function and effect as have been explained in the above embodiment 5 shown in FIGS. 3 and 4. The heat-resistant sealing material before synthesizing contains alumina (Al₂O₃) and magnesia (MgO) as main elements (effective elements) as same as this embodiment 1.

### Test Example

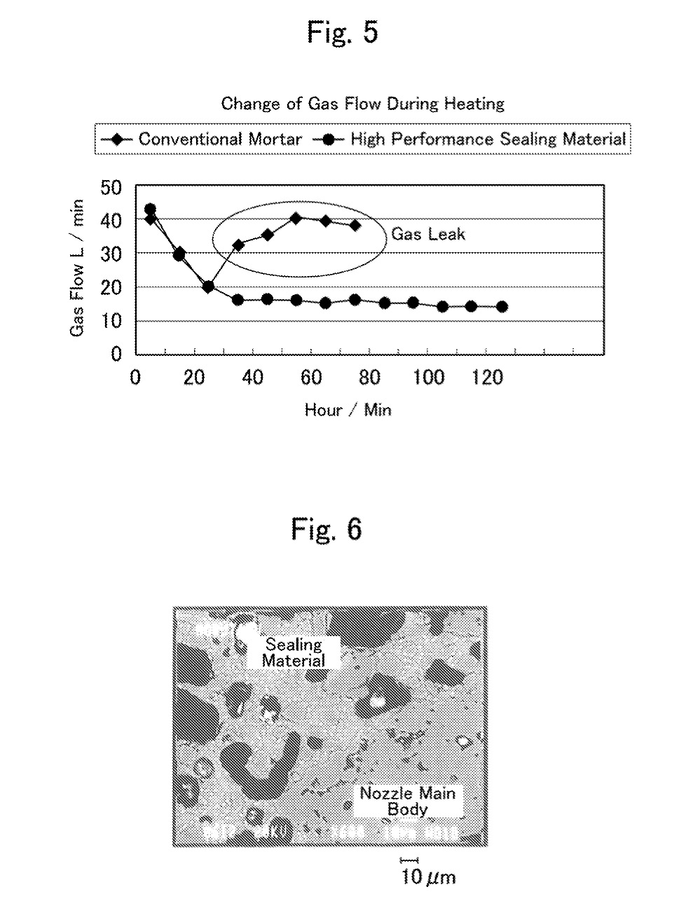

The test was made for the heat-resistant sealing material. In ceramics in the heat-resistant sealing material, mass ratio 70% of alumina particle (Al₂O₃) having the particle diameter of 75 μm or less, 15% of alumina particle (Al₂O₃) having the particle diameter of 10 μm or less and 15% of silica particle (SiO₂) having the particle diameter of 1 μm or less was mixed in this test example. The heat-resistant sealing material was formed by mixing the dispersion medium of water and ceramics. This heat-resistant sealing material was coated at the boundary area of the first member (material: high alumina) and the second member (material: high alumina). The thickness of the coating was made in 1 mm. And the gas was flown from the inlet to the outlet while heated at 1500° C. with flame from a burner. And the amount of gas leakage from the outlet was measured. The back pressure of the nozzle was maintained to 0.2 kg/cm². Another test was performed with use of the mortar adopted conventionally as a reference example in the same condition of the test example. The results of the test were shown in FIG. 5. The mark in the FIG. 5 shows the test example of the present invention. ♦ shows the reference example. The amount of leaked gas had been increasing from passing 20 minutes since the test started in the reference example as shown with ♦ mark in FIG. 5. In addition, the leaked gas flow quantity was not increased after 120 minutes from the start of the test in the reference example as it is shown with the mark in FIG. 5. From these results, it is revealed that the heat-resistant sealing material of the present invention has its stability in high temperature range.

The seal layer after 120 minutes from the start was observed with the optical microscope. Its results are shown in FIG. 6. As shown in FIG. 6, the sealing agent constituting the sealing layer is closely contacted to the nozzle main body. It seemed that melting of a part of the boundary between the nozzle main body and the sealing layer would have been started. It is considered that the micro silica particles had melted. The pores in island type (black part) were created in the sealing layer, these pores were not opened, and had been closed. The gas cannot penetrate the closed pores. From this fact, the inventors found that the sealing function of the present invention has been improved on the sealing layer. With regard to the reason why the pores were closed, the volume expanded more than the volume before the reaction due to the mullite synthesizing. It is considered that the volume expansion is favored to the creation of the closed pores rather than the creation of the open pores. In addition, the ceramics parts except the pores in the sealing layer were dense. From this fact, it is also confirmed that the sealing function of the present invention could be further improved on the sealing layer.

### Embodiment 7

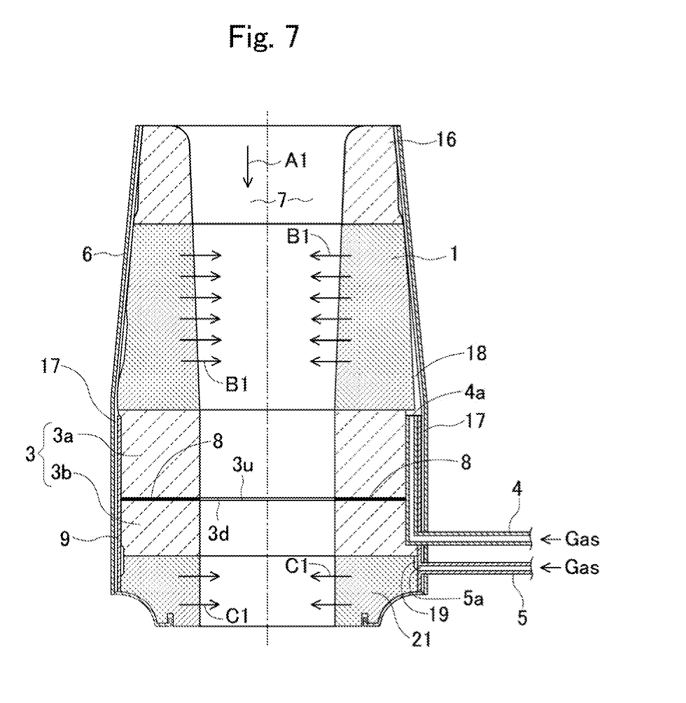

FIG. 7 shows the embodiment 7. This embodiment has the same constitution and same functional effect with the above explained embodiment basically. The same numerals and symbols shall be given to the same part. As shown in FIG. 7, the sealing layer 8 is created by filling of the heat-resistant sealing material between the upper dense refractory material 3a and the lower dense refractory material 3b. The heat-resistant sealing material before synthesizing which forms the sealing layer 8 contains the alumina (Al₂O₃) and silica (SiO₂) as main elements (Effective elements). With regards to the heat-resistant sealing material before synthesizing, it is preferable to contain more alumina (Al₂O₃) than silica (SiO₂) in mass ratio. The gas may be passed in a minute amount through the dense refractory material 3 even though it has low gas penetration because it is formed with the dense baking refractory material baked different with the non-baked castable. In other words, the gas may be leaked to the lower dense refractory material 3b by passing a part of the gas supplied to the upper porous refractory material 1 through the upper dense refractory material 3a. By the same way, a part of the gas supplied to the lower porous refractory material 2 may be leaked to the upper dense refractory material 3a by penetrating through the inside of the lower dense refractory material 3b. As shown in FIG. 1, the sealing layer 8 is interposed in the boundary area among the lower surface 3d of upper dense heat-resistant sealing material 3a and upper surface 3u of lower dense heat-resistant sealing material 3b according to this embodiment. Owing to this structure, the gas leakage from the upper dense refractory material 3a to the lower dense refractory material 3b can be blocked. In addition, the gas leakage from the lower dense refractory material 3b to the upper dense refractory material 3a can be blocked. Consequently, the gas supply to the upper porous refractory material 1 and the lower porous refractory material 2 can be performed independently of each other.

### Embodiment 8

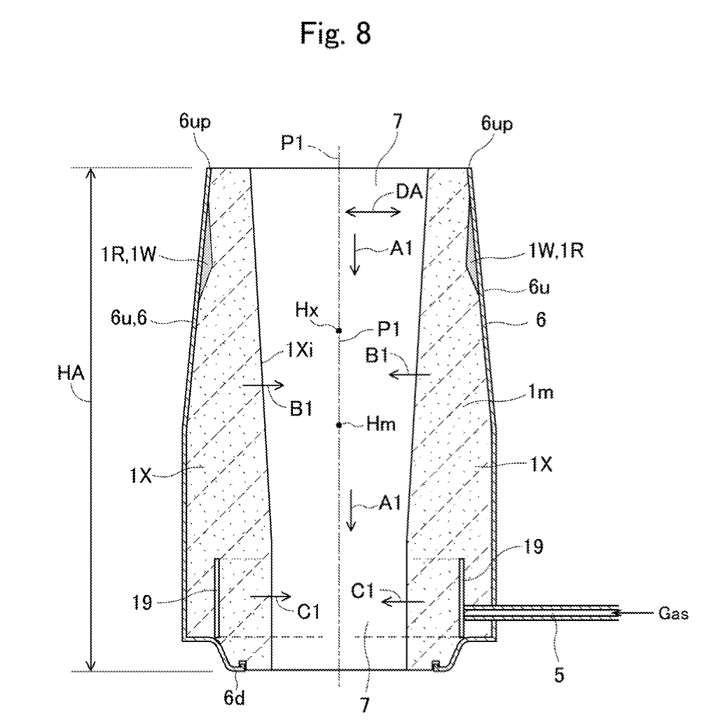

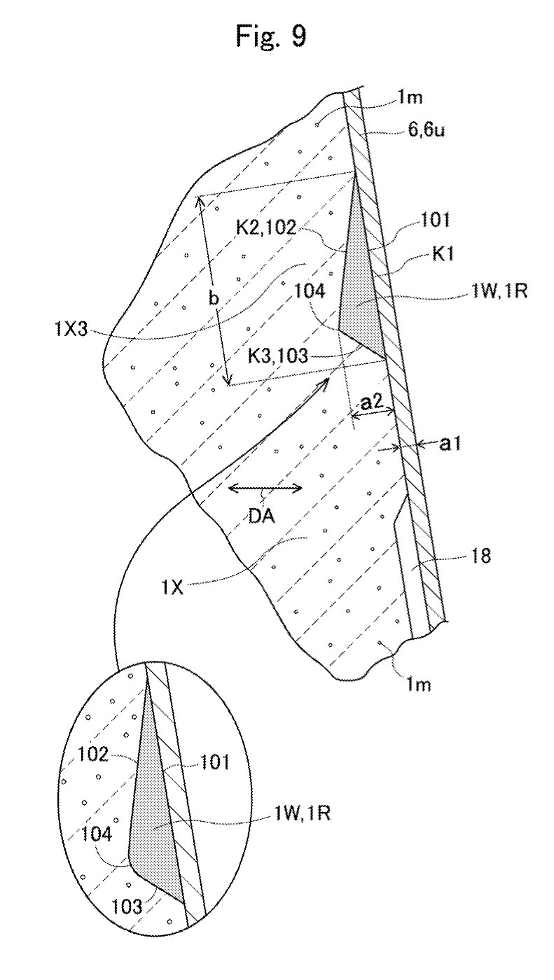

FIGS. 8 and 9 show this embodiment 8. The blowing nozzle (tundish upper nozzle, high-temperature assembly) is equipped on the bottom of the tundish which is the molten metal bath to store the high temperature molten metal (for example, molten steel). The blowing nozzle is composed of a tubular porous refractory material 1X with gas permeability (one of the first member and second member) and a tubular exterior iron cover 6 (another one of the first member and second member) made of metal (iron series) surrounding the porous refractory material 1X. A ring shaped gas pool 19 is formed inside the tubular porous refractory 1X. A gas induction pipe 5 is installed as a lower gas induction channel which supplies the intake gas to the gas pool 19. The channel 7 for passing molten metal vertically which extends to the upper and lower direction is formed on the tubular porous refractory material 1X. The porous refractory material lx has many fine pores lm which can pass the gas along the direction of its thickness, with regards to the material of it, for example, the alumina series, magnesia series and zirconia series can be taken.

As it is shown in the FIG. 8, the concave shape pool part 1W in ring shape was formed around the axial line P1 at the boundary between the tubular porous refractory material 1X and tubular exterior iron cover 6. The concave shaped pool part 1W is made in ring shape to full circle around the upper part of the exterior part of the tubular porous refractory material 1X. The non-baked heat-resistant sealing material is filled at the concave shaped pool part 1W in assembly.

This heat-resistant sealing material is baked (synthesized) by the heating in pre-heating, heating before the high-temperature assembly use (loading) or heating due to the molten bath at use of high temperature assembly. Thus the sealing layer 1R in ring shape around the axial line P1 is formed. The sealing layer 1R is expanded by the residual expansion along the diameter direction and height direction due to the baking (synthesizing). Owing to this result, the boundary area between the upper part of the tubular porous refractory material 1X and the upper part of the tubular exterior iron cover 6 is sealed. Especially, the residual expansion amount of the sealing layer 1R is fairly acquired along the diameter direction because the sealing layer 1R after synthesizing is thicker than the exterior iron cover 6. Thus the boundary area between the upper part of the tubular porous refractory material 1X and the upper part of the tubular exterior iron cover 6 is sealed in good condition. Thus the sealing layer 1R inhibits the gas flown into the gas pool 18 from leaking from the boundary area to the upper part 6up of the exterior iron cover 6. The entire height of the iron cover 6 (assembly) is expressed with HA, the central location of the height is expressed with Hm and the point in the place of ⅔ from the lower part 6d out of the height dimension is expressed with Hx. As it is shown in FIG. 8, the sealing layer 1R is located at the higher part than the location Hm on the iron cover 6. Accordingly, the sealing layer 1R is located at the upper 6u in a conical shape which has the diameter decreasing for the upper edge 6up in the iron cover 6. Especially, it is preferable that the sealing layer 1R is located on the higher part than Hx on the iron cover 6 in vertical direction. The reason is because it is preferable that the sealing property on the upper part of the iron cover 6 is heightened as the upper part of the iron cover 6 due to exposion to the severe high temperature environment by heating severely on the upper part of the iron cover 6 by the molten bath inside the tundish. Owing to this, the sealing layer 1R inhibits the gas flown into the gas pool 19 from leaking to the upper part 6up of exterior iron cover 6. In addition, the amount of the thermal expansion along the diameter direction of the iron cover 6 is considered smaller than the expansion amount along the radial direction of the tubular porous refractory material 1X.

The heat-resistant sealing material making the above described pool part 1R before synthesizing contains the alumina (Al₂O₃) and silica (SiO₂) as main elements (effective elements). It is preferable that the composition of the heat-resistant sealing material contains more alumina (Al₂O₃) than silica (SiO₂) in its mass ratio. For example, the heat-resistant sealing material formed by mixing the material comprising silica (SiO₂) and more alumina (Al₂O₃) than silica with water are used. The alcohol and so on can be used for dispersion medium. And such heat-resistant sealing material is filled in the concave shaped pool part 1W. When the blowing nozzle is used in this state, the blowing nozzle is maintained in the high temperature area. In this case, for example, the high temperature molten metal in 1400˜1700° C. flows through the channel 7 in the arrow direction A1. In use for the high temperature assembly as it was explained, the following reaction represented in formula (1) is taken place in the sealing agent due to the influent heat from the high temperature molten metal. The iron cover 6 and refractory material lx can contribute to the heating of the sealing agent as it is thermal conductive.

2SiO₂+3Al₂O₃→3Al₂O₃·2SiO₂ (1)

As it is shown, mullite (3Al₂O₃·2SiO₂) is synthesized from SiO₂ of mole ratio 2 and Al₂O₃ of mole ratio 3. The volume of the synthesized 3Al₂O₃·2SiO₂ (mullite) expands than before the reaction. Even though the sealing layer 1R in which mullite is made is dense or it contains pores, the pores are closed. The heating process (synthesizing process) does not have to be performed independently as the volume of the mullite (3Al₂O₃·2SiO₂) expands more than before the reaction because the mullite (3Al₂O₃·2SiO₂) is synthesized due to the heat in use of the gas blowing nozzle which is a high temperature assembly as shown in the above. Here, the easier the synthesizing reaction represented in formula (1) occurs, the smaller the particle diameters of silica particle (SiO₂) and alumina particle (Al₂O₃) are. Thus it is preferable that the diameters of the silica particle (SiO₂) and alumina particle (Al₂O₃) are small. The particle diameters of silica particle (SiO₂) and alumina particle (Al₂O₃) are preferably either 100 μm or less, 30 μm or less, 10 μm or less, or 3 μm or less, specially 1 μm or less.

Next, the gas flow in use of the gas blowing nozzle in the embodiment in the continuous casting is explained. The molten metal such as the molten steel inside the tundish transferred from the ladle flows towards the continuous caster during use, but the molten metal flows downwards (in the direction of arrow A1 shown in FIG. 1) inside the channel 7. In this case, the gas (for example, an inactive gas like argon gas) is supplied to the gas induction pipe 5 from the gas source. The gas supplied to gas supply pipe 5 is supplied to the porous part of porous refractory 1X through the gas pool 19 and is blown out from the inner periphery face 1Xi to channel 7 (in the direction of arrow C1 and B1). The blown gas inhibits alumina from attachment on sliding plate, collector nozzle and immerse nozzle on the tundish sliding nozzle equipment. In addition, the heat-resistant sealing material forming the sealing layer 1R has a composition with difficulties in forming the gap at the boundary between the outer periphery of the tubular porous refractory material 1X and the exterior iron cover 6 because its volume is increased by baking. Accordingly, it is difficult to leak the gas at the boundary area when it keeps high temperature at use. In addition, the heat-resistant sealing material before synthesizing can contain at least either of kyanite and andalusite depending on necessity.

FIG. 9 shows the sealing layer 1R and the vicinity thereof formed by the baking (synthesizing) the heat-resistant sealing material. Here, assuming that the thickness of the exterior iron cover 6 is represented as “a1”, the maximum thickness of the sealing layer 1R after synthesizing is represented as “a2” and the height of the sealing layer 1R is represented as “b”, it is desirable to set the relation thereof being “a1<a2” or “a1<a2<b” to enhance the sealing performance around the sealing layer 1R. However, the relationship is not limited to the above relations and any other relation may be applied as long as such can perform the effect of the invention. The high sealing performance can be obtained due to the sealing distance “b” (the length of the oblique side 101) of sealing layer 1R, wherein the relation “a2<b” is established. In addition, as the tubular porous refractory 1X for forming the sealing layer 1R, being porous having a lot of pores, the expansion thereof is absorbed in pores of the tubular porous refractory material 1X and the expansion amount of the sealing layer 1R is limited. According to the embodiment above, it is advantageous in acquiring sufficient expansion amount and high sealing performance because of the ring shape sealing layer 1R which can expand as residual expansion in the diameter direction and height direction by synthesizing. As shown in FIG. 9, the upper part of the tubular porous refractory material 1X (refractory material) on the upper part 6u of the iron cover 6 is formed to be in conical shape and the thickness in the diameter direction decreases toward the upper part 6u of the iron cover 6. In this case, the tubular porous refractory material DC may crack due to the lack of strength when the environmental condition is severe. As shown in FIG. 2, the concave shaped pool part 1W and sealing layer 1R have triangular shape in cross section. The triangle shape has an oblique side 101 along the internal wall of the iron cover 6, an upper oblique side 102 facing to the tubular porous refractory material 1X, a lower oblique side 103 facing to the tubular porous refractory material 1X and a crossing part 104 crossing the oblique sides 102 and 103. As shown in the FIG. 9, the length of the oblique side 101 is expressed as K1, the length of the oblique side 102 is expressed as K2 and the length of the oblique side 103 is expressed as K3. The relation therebetween is expressed as “K2>K3” or “K2>K1>K3”. The crossing part 104 in the sealing layer 1R is located at the lower part relatively. Owing to this structure, the part 1X3 (refer to FIG. 9) facing to the oblique side 102 out of the tubular porous refractory material 1X acquires the thickness of the diameter direction (arrow direction DA). K3/K2=0.8 or less, 0.6 or less, or 0.4 or less is exemplified. The crossing part 104 preferably has roundness. However, K2=K3, K3>K2 can be acceptable in case cracking is not expected. In some cases, the cross sections of the concave shape pool part 1W and sealing layer 1R can be made in a trapezoidal shape approximately.

### Embodiment 9

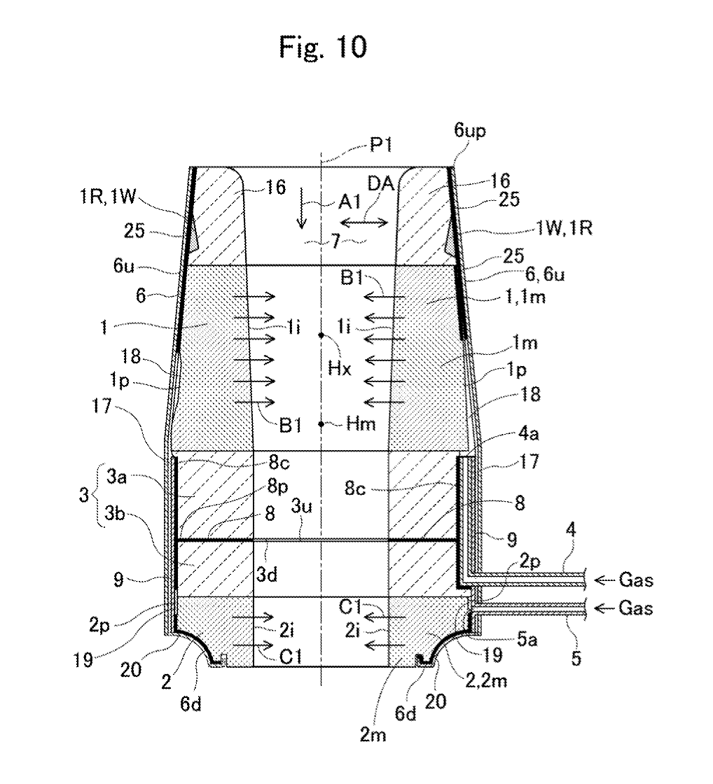

FIG. 10 shows an embodiment 9. This embodiment has the same constitution and same functional effect with the embodiments 1 and 8 basically. As it is shown on the FIG. 10, the blowing nozzle (tundish upper nozzle, high temperature assembly) is equipped with an upper porous refractory material 1 with gas penetration located at the relatively upper part, a lower porous refractory material 2 with gas penetration located at the relatively lower part than the upper porous refractory material 1, a dense refractory material 3 interposed between the upper porous refractory material 1 and lower porous refractory material 2, an upper gas induction pipe 4 to supply intake gas to the upper porous refractory material 1, a lower gas induction pipe 5 to supply intake gas to the lower porous refractory material 2, an exterior iron cover 6 having a tubular shape to function as a metal cover to surround and hold the outer periphery face of the upper porous refractory material 1, dense refractory material 3 and lower porous refractory material 2. A channel 7 for passing molten metal which extends to the upper and lower direction is formed. In addition, numeral 16 is a sub dense refractory material stacked on the top of the upper porous refractory material 1. The upper gas pool 18 in ring shape is formed between the tubular porous refractory material 1X and tubular exterior iron cover 6. The lower gas pool 19 in ring shape is formed inside the tubular porous refractory material 1X. As it is shown in FIG. 10, the dense refractory material 3 is divided into the upper dense refractory material 3a and lower dense refractory material 3b. The heat-resistant sealing material is synthesized by filling between the upper dense refractory material 3a and lower dense refractory material 3b. Accordingly, the sealing layer 8 after synthesizing is formed. The iron cover (interior metal cover) 9 is equipped with installation of the shrink-fitting on the outer periphery of the upper dense refractory material 3a, lower dense refractory material 3b and lower porous refractory material 2. The iron cover 9 is located at the inner periphery of the exterior iron cover 6. This part is a double layered iron cover. The sealing layer 17 is installed between the iron cover 6 (the first member) and iron cover 9 (the first member).

As it is shown in FIG. 10, the upper gas induction pipe 4 is introduced to face the edge 4a thereof upwards along the outer periphery of the dense refractory material 3. The edge 4a of the upper gas induction pipe 4 is connected to the exterior part 1p of the upper porous refractory material 1 through the ring-shape or tubular gas pool 18. The gas leaking is inhibited as the sealing layer 8c is formed by filling the heat-resistant sealing material same with the sealing layer 8 at the boundary area between the inner periphery of the iron cover 9 and the outer periphery of the dense refractory material 3. The lower gas induction pipe 5 is introduced for its edge 5a to be faced horizontally and it is connected to the exterior part 2p of the lower porous refractory material 2 through the ring shaped gas pool 19. The upper porous refractory material 1 and lower porous refractory material 2 have many fine pores to be able to pass gas and it is preferable that both of the porous refractory materials 1, 2 are made of the same material or the same series material each other. Alumina series, magnesia series and zirconia series can be exemplified of the material. The dense refractory material 3 and the sub dense refractory material 16 have high denseness and high strength as its pore ratio is very low and gas permeation is low, as differently with the non-baked castable layer, as it is formed with the baked refractory material to be dense. In the other words, the dense refractory material 3 has the denseness as its gas penetration property is lower than the upper porous refractory material 1 and lower porous refractory material 2.

The heat-resistant sealing material before synthesizing which forms the sealing layers 8, 8c and 17 comprises alumina (Al₂O₃) and silica (SiO₂) as main elements (effective elements). The composition of the heat-resistant sealing material before synthesizing comprises more alumina (Al₂O₃) than silica (SiO₂) in mass ratio. For example, it is used the heat-resistant sealing material formed by mixing the material comprising silica (SiO₂) and more alumina (Al₂O₃) than silica (SiO₂) with water or alcohol. And the heat-resistant sealing material is applied at the boundary area between the lower surface 3d of the upper dense refractory material 3a (the first member.) and the upper surface 3u of the lower dense refractory material 3b (the second member). The heat-resistant sealing material is also filled at the concave shape pool part 1W formed at the outer periphery of the tubular porous refractory material 1X. Thus the sealing agent before synthesizing is coated at the boundary area. When the blowing nozzle is used in this state, the blowing nozzle is maintained in the high temperature area. In this case, for example, the high temperature molten metal in 1400˜1600° C. flows inside the channel 7 to the arrow direction A1. In use for the high temperature assembly, the following reaction represented in formula (1) is taken place on the sealing agent due to influent heat from the high temperature molten metal. The iron covers 6, 9 and the refractory materials 1, 2, 3a, 3b, 16 have thermal conductivity so as to contribute the heating of the heat-resistant sealing material.

2SiO₂+3Al₂O₃→3Al₂O₃·2SiO₂ (1)

As it is shown, mullite (3Al₂O₃·2SiO₂) is synthesized from SiO₂ of mole ratio 2 and Al₂O₃ of mole ratio 3. The volume of the synthesized 3Al₂O₃·2SiO₂(mullite) expands than before the reaction. The heating process of synthesizing does not have to be performed independently as the volume expands more than before the reaction (baking) because mullite (3Al₂O₃·2SiO₂) is synthesized the volume of which expands than before synthesizing due to the heat in use of the gas blowing nozzle which is a high temperature assembly as shown in the above. Here, Easier the synthesizing reaction represented in formula (1) is taken place, the smaller the particle diameters of silica particle (SiO₂) and alumina particle (Al₂O₃) are. Thus it is preferable that the diameters of the silica particle (SiO₂) and alumina particle (Al₂O₃) are small. The particle diameters of silica particle (SiO₂) and alumina particle (Al₂O₃) is preferably 100 μm or less, 30 μm or less, 10 μm or less, or 3 μm or less, especially 1 μm or less.

Next, the gas flow in use of the gas blowing nozzle in this embodiment in the continuous casting is explained. The molten metal such as molten steel inside the tundish transferred from the ladle flows towards the continuous caster during use. The molten metal flows downwards (in the direction of arrow A1 shown in FIG. 1) inside the channel 7. In this case, the gas (for example, an inactive gas like argon gas) is supplied to the upper gas induction pipe 4 and lower gas induction pipe 5 from the gas source. The gas supplied to upper gas induction pipe 4 is supplied to the porous part of the porous refractory material 1 through the gas pool 18 and is blown out from the inner periphery face 1i of the upper porous refractory material 1 to the channel 7 (direction of arrow B1). The blown gas inhibits alumina from attachment at the top of the nozzle. The gas supplied to the lower gas supply pipe 5 is supplied to the porous part of the lower porous refractory 2 through the gas pool 19 and is blown out from the inner periphery face 2i of the lower porous refractory material 2 to the channel 7 (direction of arrow C1). The blown gas inhibits alumina from attachment on a sliding plate, collector nozzle and immerse nozzle in the tundish sliding nozzle equipment.

According to this embodiment, as it is shown in the FIG. 10, the concave shape pool part 1W in ring shape was formed around the axial line P1 at the boundary between the outer periphery of the tubular dense refractory 16 and the inner periphery of the tubular exterior iron cover 6. The concave shaped pool part 1W is made in ring shape to full circle around the outer periphery of the tubular porous refractory material 1X. The heat-resistant sealing material is charged at the concave shaped pool part 1W in assembly. This heat-resistant sealing material makes the sealing layer 1R through the baking by the heating at use. The sealing surface 1R after synthesizing is thicker than iron cover 6 and it is formed in ring shape around the axis line P1. The sealing surface 1R seals the boundary area between the upper part of the tubular porous refractory material 1X and the upper part of the tubular exterior iron cover 6. Owing to this result, the sealing layer 1R prevents the gas, supplied from the gas pool 18, from leaking the boundary area, that is, the outside from the upper part of the exterior iron cover 6. The sealing layer 1R is located at the higher part than the Hm location on the iron cover 6. Especially, it is preferable for the sealing layer 1R to position on the higher part than the Hx location on the iron cover 6. The iron cover 6 is severely heated from the upper part thereof by the high temperature molten bath in the tundish. The upper part of the iron cover 6 is exposed to the severe high temperature environment. Therefore, the improving the sealing property is preferable. The sealing layer 1R prevents the gas, supplied from the gas pool 18, from leaking out from the upper of the exterior iron cover 6. In some cases, the sealing layer 1R may be positioned between the position Hx and the position Hm. As it is shown in FIG. 3, the refractory material 16 holding the sealing layer 1R is a dense material and has very low porosity. Owing to this, it can contribute to heighten the sealing property by inhibiting the expansion amount along the diameter direction on the sealing layer 1R from be absorbed by the dense refractory material 16.

The gas may be passed in a minute amount through the dense refractory material 3 even though gas penetration property thereof are small because the dense refractory material 3 is formed of the dense baking refractory material baked as differently with the non-baked castable. In the other words, a part of the gas supplied to the upper porous refractory material 1 is going to leak to the lower dense refractory material 3b through the upper dense refractory material 3a. By the same way, a part of the gas supplied to the lower porous refractory material 2 is going to leak to the upper dense refractory material 3a through the lower dense refractory material 3b. But in this embodiment, the sealing layer 8 is interposed at the boundary area between the lower surface 3d of the upper dense refractory material 3a and the upper surface 3u of the lower dense refractory material 3b according to this embodiment. Owing to this, the leak from the upper dense refractory material 3a to the lower dense refractory material 3b is blocked. In addition, the leak from the lower dense refractory material 3b to the upper dense refractory material 3a is blocked. Consequently, the gas supply to the upper porous refractory material 1 and the lower porous refractory material 2 can be performed independently.

In addition, the heat-resistant sealing material forming the sealing layer 8 has a composition with difficulties in forming the gap between the upper dense refractory material 3a and the lower dense refractory material 3b because its volume increases by baking. Accordingly, it is difficult to leak the gas from sealing layer 8 when it keeps high temperature at use. In addition, iron cover 9 as a metal cover which surrounds the outer periphery face of the upper dense refractory material 3a, lower dense refractory material 3b and lower porous refractory material 2 is installed. The gas flowing along the outer periphery of the upper dense refractory material 3a, lower dense refractory material 3b and lower porous refractory material 2 is inhibited because the external edge 8p of the sealing layer 8 is contacted to the inner periphery wall of the iron cover 9. Accordingly, it becomes more favorable to supply the gas independently to upper porous refractory material 1 and lower porous refractory material 2. In addition, a sealing layer 8c which is made of the same heat-resistant sealing material with sealing layer 8 is filled between the iron cover 9 and dense refractory material 3 which contact to the pipe 4. The gas is not leaked through the exterior of the pipe 4 owing to this. Accordingly, the gas supply can be performed more independently to the upper porous refractory material 1 and lower porous refractory material 2.

According to this embodiment, the sealing layer 8 is formed by filling the heat-resistant sealing material between the upper dense refractory material 3a and the lower dense refractory material 3b. The set of the upper porous refractory material 1 and the upper dense refractory material 3a and the set of the lower porous refractory material 2 and the lower dense refractory material 3b can be assembled by gluing with the heat-resistant sealing material constituting the sealing layer 8. In addition, according to this embodiment, as it is described in the above, the sealing layer 17 formed of the heat-resistant sealing material is interposed between the iron cover 6 (one of the first and second members) and the iron cover 9 (the other one of the first and second members). The silica particle (SiO₂) and alumina particle (Al₂O₃) are mixed into the refractory material forming sealing layer 17 as effective elements. The sealing layer 20 is formed at the boundary area between the lower part 6d of the external iron cover 6 (one of the first and second members) and the lower part porous refractory material 2 (the other one of the first and second members) by coating the heat-resistant sealing material. Moreover, the sealing layer 25 is formed at the boundary area between the inner periphery of the upper part 6u of the exterior iron cover 6 (the first member) and the outer periphery of the upper porous refractory material 1 (the second member), and at the boundary area between the inner periphery of the upper part 6u of external iron cover 6 (the first member) and the outer periphery of the sub dense refractory material 16 (the second member) by coating the heat-resistant sealing material.

And the sealing agent constituting the sealing layer 1R and the sealing layer 8, 8c, 17, 20 and 25 is made of above described heat-resistant sealing material. The sealing layer 1R and the sealing layer 8, 8c, 17, 20, 25 are heated at high temperature in use of the blowing nozzle due to the transferred heat from molten metal such as molten steel because the high temperature molten metal such as molten steel passes through the channel 7. Therefore, the silica particle (SiO₂) and alumina particle (Al₂O₃) constituting the sealing agent synthesize mullite the volume of which increases. Owing to this, the sealing property of the above described sealing layers 8, 8c, 17, 20 and 25 described in the above can be heightened. Depending on situation, the sealing layer 1R, 8, 8c, 17, 20 and 25 can be heated at high temperature by pre-heating before use or heating before the assembly loading. In addition, as it is described in detail in the above, even though the sealing layer 8, 8c, 17, 20 and 25 are formed of the heat-resistant sealing material according to this embodiment, without limitation to this, at least one of the sealing layer 8, 8c, 17, 20 and 25 is formed of the heat-resistant sealing material according to this embodiment and the formation of the others with publically known sealing agent (mortar and etc) is accepted. In addition, the heat-resistant sealing material before synthesizing may contain at least either of the kyanite and andalusite depending on necessity.

### Embodiment 10

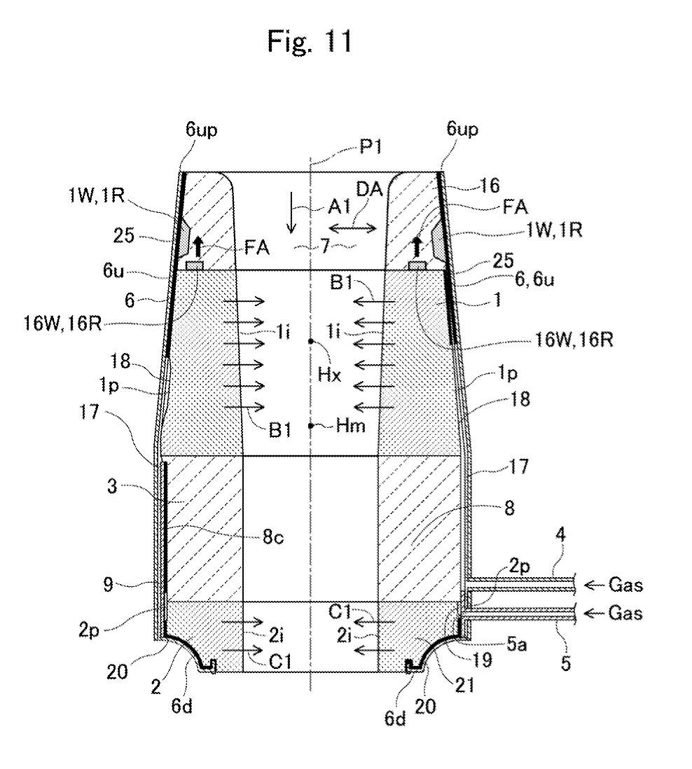

FIG. 11 shows the embodiment 10. This embodiment has the same constitution and same functional effect with above embodiment basically. As shown in FIG. 11, according to this embodiment, the concave shaped pool part 1W in ring shape is formed around the axial line P1 at the boundary between the tubular dense refractory material 16 and the tubular exterior iron cover 6. The concave shaped pool part 1W is made in ring shape to full circle around the outer periphery of the tubular dense refractory material 16. The non-baked or semi-baked heat-resistant sealing material is filled at the concave shaped pool part 1W in assembling. This heat-resistant sealing material forms the sealing layer 1R by baking due to the heat from molten bath passing through the channel 7 when in use. The sealing layer 1R is formed in ring shape around the axis line P 1. The sealing layer 1R, which is formed by mullite and spinel which have the tendency of expanding when synthesized, expands along in the diameter direction (DA direction) and height direction. At a result, it seals boundary area between the outer periphery of the dense refractory material 16 and the inner periphery of the tubular exterior iron cover 6. Owing to this result, the sealing layer 1R prevents the gas, which is supplied from the gas pool 18, from leaking through the boundary area to the upper side 6up of iron cover 6.

According to this embodiment, as is shown in FIG. 11, the concave shaped pool part 16W in ring shape is formed around the axial line P1 at the boundary between the upper porous refractory material 1 and the sub dense refractory material 16. The non-baked heat-resistant sealing material is filled at the concave shaped pool part 16W. The filled heat-resistant sealing material is baked (synthesized) by any of the heat from the molten metal bath when in use, heating before use of the high-temperature assembly and heating before loading of the high-temperature assembly and it makes mullite or spinel to expand in the radial direction and in the height direction thereby to form the sealing layer 16R. This expansion remains as a residual expansion. As a result, this residual expansion exerts a biasing force (refer to the FIG. 11) directing towards the upper edge 6up of external iron cover 6. As the result, according to this structure, it is advantageous to closely contact the outer periphery of the conical shape (conical shape, the diameter of which decreases toward the upper side) of the sub dense refractory material 16 to the inner periphery of the conical shape (conical shape, the diameter of which decreases toward the upperside). Accordingly, the sealing performance at the boundary area between the outer periphery of the conical-shape sub dense refractory material 16 and inner periphery of the cone-shaped external iron cover 6 can be further improved. In addition, the heat-resistant sealing material before synthesizing can contain at least either of kyanite and andalusite depending on necessity. As shown in FIG. 11, the sealing layer 1R is located at the higher part than the Hm of the central location in the height on the iron cover 6. Especially, it is desirable for the sealing layer 1R to be positioned higher than the position Hx on the iron cover 6 in vertical direction. The reason is that the improving of sealing performance on the upper part of the iron cover 6 is desirable due to the exposure of the upper part of the iron cover 6 to the severe high temperature environmental location at the bottom of the molten bath such as tundish. The cross section of the concave pool part 1W and the sealing layer 1R has approximately a trapezoidal shape and cross section thereof may have a triangular shape. In addition, the heat-resistant sealing material before synthesizing can contain at least either of kyanite and andalusite depending on necessity.

(Others) The present invention is not confined to this embodiment shown on the above drawings. It can be performed through modification properly within the range out of the key point. It is good to apply to the immersed pipe of vacuum gas removing equipment as a high-temperature assembly.

### INDUSTRIAL APPLICABILITY

The high-temperature assembly of the present invention can be used widely for the high temperature area where the metal bath such as molten steel, molten cast, aluminum molten bath, titan molten bath is used and high temperature area exposed to the gas in high temperature. The combination of the first and second member may be refractory material—refractory material, metal—metal, refractory material—metal or metal—refractory material. A brick such as regular brick, a castable dried and solidified flexible a refractory material having fluidity are exemplified as the refractory material. The metal shell body and metal panel can be exemplified as the metal. The sealing layer expanded by synthesizing may seal at the boundary between the first dense refractory material and the second dense refractory material. The sealing layer expanded by synthesizing may seal at the boundary between the first porous refractory material and the second porous refractory material.

The sealing layer expanded by synthesizing may seal at the boundary between the porous refractory material and the dense refractory material. The sealing layer may seal between at least either of the porous refractory material and dense refractory material, and iron cover.

1. A high-temperature assembly being used in high temperature, comprising at least first and second members and a heat-resistant sealing material provided at a boundary area between said first and second members, characterized in that said heat-resistant sealing material comprises first and second ceramic particles as effective elements forming a ceramics the volume of which increases when said ceramics is synthesized.

2. The high-temperature assembly according to claim 1, characterized in that said ceramics, the volume of which increases when said ceramics is synthesized, is mullite, said first ceramic particle is formed of silica and said second ceramic particle is formed of alumina.

3. The high-temperature assembly according to claim 1, characterized in that said ceramics, the volume of which increases when said ceramics is synthesized, is spinel, said first ceramic particle is formed of magnesia and said second ceramic particle is formed of alumina.

4. A method for producing a high-temperature assembly characterized in that the method comprises the steps of:
a first process for preparing a heat-resistant sealing material comprising first and second ceramic particles as effective elements and forming a ceramics the volume of which increases when said ceramics is synthesized and first and second members;
a second process for forming an assembly by assembling said first and second members, wherein said heat-resistant sealing material before being synthesized is interposed at a boundary area between the first and second members; and
a third process for baking said heat-resistant sealing material by heating at least at one of a using temperature of said assembly at use, a heating temperature of said assembly before use and a heating temperature of said assembly before loading with interposing said heat-resistant sealing material at the boundary between said first member and said second member and synthesizing said first and second ceramic particles to form a ceramics the volume of which increases thereby to seal the boundary area between the first and second members of said assembly.

5. The method of producing a high-temperature assembly according to claim 4, characterized in that said ceramics, the volume of which increases when said ceramics is synthesizsd, is mullite, said first ceramic particle is formed of silica and said second ceramic particle is formed of alumina.

6. The method of producing a high-temperature assembly according to claim 4, characterized in that said ceramics, the volume of which increases when said ceramics is synthesized, is spinel, said first ceramic particle is formed of magnesia and said second ceramic particle is formed of alumina.

7. The method of producing a high-temperature assembly according to claim 4, characterized in that when said ceramics in said heat-resistant sealing material of said first process is set in 100%, said heat-resistant sealing material comprises 0.01˜40% of either or both of andalusite and kyanite in mass ratio.

8. A heat-resistant sealing material before synthesizing located at the boundary area between first and second members, characterized in that comprising first and second ceramic particles as effective elements to forming a ceramics the volume of which increases when the ceramics is synthesized.

9. The heat-resistant sealing material according to claim 8, characterized in that said ceramics, the volume of which increases when said ceramics is synthesized, is mullite, said first ceramic particle is formed of silica and said second ceramic particle is formed of alumina.

10. The heat-resistant sealing material according to claim 8, characterized that said ceramics, the volume of which increases when said ceramics is synthesized, is spinel, said first ceramic particle is formed of magnesia and said second ceramic particle is formed of alumina.

11. The heat-resistant sealing material according to claim 8, characterized a particle diameter of one of said first and second ceramic particles is 30 μm or less and a particle diameter of the other of said first and second ceramic particles is 200 μm or less.

12. The heat-resistant sealing material according to claim 8, characterized in that when said ceramics in said heat-resistant sealing material is set in 100%, said heat-resistant sealing material comprises 0.01˜40% of either or both of andalusite and kyanite in mass ratio.
